(19) United States
(12) Patent Application Publication
(10) Pub. No.: US 2026/0170715 A1
(43) Pub. Date: Jun. 18, 2026

(54) MULTISPECTRAL ANALYSIS USING A SMARTPHONE CAMERA FOR MEASURING CONCENTRATIONS OF LIGHT-EMITTING COMPOUNDS

(71) Applicant: UNIVERSITY OF WASHINGTON, Seattle, WA (US)

(72) Inventors: Ruikang K. Wang, Seattle, WA (US); Qinghua He, Seattle, WA (US)

(73) Assignee: UNIVERSITY OF WASHINGTON, Seattle, WA (US)

(21) Appl. No.: 19/124,184

(22) PCT Filed: Oct. 26, 2023
(86) PCT No.: PCT/US2023/077963

§ 371 Date: Apr. 24, 2025

Related U.S. Application Data
(60) Provisional application No. 63/420,448, filed on Oct. 28, 2022.

(51) Int. Cl. G06T 11/10

(52) U.S. Cl. CPC G06T 11/10

(57) ABSTRACT

In some embodiments, a computer-implemented method of measuring light-emitting compounds using a smartphone is provided. The smartphone determines a transformation matrix using one or more options specified via a configuration user interface. The smartphone transforms a low-color space image that depicts at least a subject into a multispectral data cube using the transformation matrix, and determines a measurement of a light-emitting compound associated with the subject using the multispectral data cube. In some embodiments, a computer-implemented method of measuring light-emitting compounds using a smartphone is provided. The smartphone transforms the low-color space image that depicts at least a subject into a multispectral data cube using a transformation matrix. The smartphone provides values from the multispectral data cube to an ensemble of two or more machine learning models, and determines a measurement of a light-emitting compound associated with the subject based on outputs of two or more machine learning models.

### CROSS-REFERENCE(S) TO RELATED APPLICATION(S)

This application claims the benefit of Provisional Application No. 63/420,448, filed Oct. 28, 2022, the entire disclosure of which is hereby incorporated by reference herein for all purposes.

### BACKGROUND

The development of mobile health based on smartphone apps facilitates daily monitoring of many vital signs and body tissue compositions. Some of them have the potential to indicate disease conditions that are difficult to detect/diagnose without physically visiting healthcare providers. Exploring and developing such techniques can clearly promote and benefit public healthcare. For example, the global incidence of liver disease (LD) is estimated at 1.5 billion, which leads to about 2 million deaths each year.

Close monitoring of at-risk population is believed to be an effective strategy to control its progression and spread. However, frequent testing through visiting the clinical labs imposes an inevitable burden to the patients, both psychologically and economically, impacting the compliance to seek for medical services. To improve the clinical compliance and promote their willingness to accept the monitoring of liver health conditions, one solution is to noninvasively detect bilirubin levels in the serum, preferably that can be performed in a non-clinical environment. The balance of BBL in the circulation relies on a normal liver metabolism, which makes it a suitable biomarker of liver functions. At different severity stages of LD, bilirubin dysbolism accumulates and eventually causes different levels of hyperbilirubinemia, which usually appears as the yellowish pigmentation in body tissue.

With distinct optical spectral properties, bilirubin-induced pigmentation is suitable to be noninvasively measured using optical sensors to estimate the BBL and finally indicate the liver condition. Some of these sensors, like transcutaneous bilirubinometer, equip spectral illumination for the detection of the light absorption to estimate BBL. We also see some portable versions of these sensors that are developed to save people from the frequent clinical visits, however, substantial investment is still required to acquire these dedicated devices, which eventually prevents them from wider spread use.

The smartphone is steadily making its way to become an indispensable tool in individual healthcare and living quality monitoring. This trend is made possible by the rapid developments of the sensing modules that are specifically tailored for smartphones, e.g., built-in cameras, microphones, and touch screens. Among these sensing modules, the camera has experienced extensive technical innovation and nowadays can deliver a comparable imaging quality to specialized medical imagers. With assembled color filters in Bayer arrangement, smartphone cameras may be able to differentiate the spectral information from collected signals in red-green-blue (RGB) channels.

However, the built-in architecture of Bayer filters in smartphone cameras inevitably limits the spectral resolution beyond that which may be use to acquire/predict accurate information regarding optical properties of biological samples, largely due to the overlap in the sensitivity ranges in the RGB channels. What is desired are techniques that allow the use of smartphones to determine optical properties of biological samples, including determining measurements of light-emitting compounds including but not limited to bilirubin concentration, hemoglobin levels, melanin levels, porphyrin concentration, and or bacteria load levels, despite the technological limitations of their RGB cameras.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a computer-implemented method of measuring light-emitting compounds using a smartphone is provided. The smartphone presents a user interface for configuring a light-emitting compound measurement application. The smartphone determines a transformation matrix using one or more options specified via the user interface. The smartphone captures a low-color space image that depicts at least a subject. The smartphone transforms the low-color space image into a multispectral data cube using the transformation matrix, and the smartphone determines a measurement of a light-emitting compound associated with the subject using the multispectral data cube.

In some embodiments, a computer-implemented method of measuring light-emitting compounds using a smartphone is provided. The smartphone captures a low-color space image that depicts at least a subject and transforms the low-color space image into a multispectral data cube using a transformation matrix. The smartphone provides values from the multispectral data cube to an ensemble of two or more machine learning models, and determines a measurement of a light-emitting compound associated with the subject based on outputs of the two or more machine learning models.

In some embodiments, a smartphone configured to perform a method as described above is provided.

In some embodiments, a non-transitory computer-readable medium having computer-executable instructions stored thereon is provided. The instructions, in response to execution by one or more processors of a smartphone, cause the smartphone to perform a method as described above.

### BRIEF DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 is a schematic illustration of a non-limiting example embodiment of a system for enabling measurement computing systems to generate predicted measurements of light-emitting compounds according to various aspects of the present disclosure.

FIG. 2 is a block diagram that illustrates aspects of a non-limiting example embodiment of a measurement computing system according to various aspects of the present disclosure.

FIG. 3 is a block diagram that illustrates aspects of a non-limiting example embodiment of a training computing system according to various aspects of the present disclosure.

FIG. 4A-FIG. 4B are a flowchart that illustrates a non-limiting example embodiment of a method for preparing a light-emitting compound measurement app to generate predicted measurements of light-emitting compounds using a variety of hardware according to various aspects of the present disclosure.

FIG. 5A-FIG. 5B are a flowchart that illustrates a non-limiting example embodiment of a method of generating predicted measurements of light-emitting compounds using a measurement computing system according to various aspects of the present disclosure.

FIG. 6 is an illustration of a non-limiting example embodiment of a configuration interface for the light-emitting compound measurement app according to various aspects of the present disclosure.

FIG. 7 is an illustration of a non-limiting example embodiment of an interface for specifying a region of interest according to various aspects of the present disclosure.

FIG. 8 is a chart that illustrates values of reflectance rate reduction at various bilirubin concentrations at 460 nm as captured by a non-limiting example embodiment of the present disclosure.

FIG. 9A and FIG. 9B show results of imaging enabled by a non-limiting example embodiment of the present disclosure on the sclera in the anterior segment of eye (bulbar conjunctiva region) in two representative clinical cases.

### DETAILED DESCRIPTION

In embodiments of the present disclosure, a mobile app is provided that can convert a variety of measurement computing systems, such as different models of smartphones, into multispectral imagers. With this app, accurate predictions can be generated of measurements of light-emitting compounds, which are then usable to predict, for example, a blood bilirubin level (BBL) in a subject. In some embodiments, machine learning models are trained to predict the measurements based on multispectral data cubes generated from low-dimensional color space images. The techniques for generating multispectral information together with the machine learning models for predicting measurements are shown to perform better than predictions using the low-dimensional color space images without enhancements. The techniques disclosed herein can be conducted without additional investments and expertise other than having an ordinary smartphone, and are therefore suitable for widespread use (especially for populations experiencing a shortage of medical resources).

One non-limiting example of a light-emitting compound that can be measured using embodiments of the present disclosure is bilirubin. As a biomarker of liver functions, bilirubin has distinct absorption in the wavelength bands between 350 and 500 nm, which can be exploited to develop optical bilirubinometer for measuring BBL in people. Aiming for a low cost and easy access, enormous effort has been paid to realize the blood bilirubin level (BBL) detection with smartphone cameras. Previous studies reported some strategies by extracting raw signals from RGB channels in photographs. The measurement accuracy of these previous techniques remains inadequate to inform clinical information. Some other studies adopted additional color calibration, image segmentation and feature extraction steps to preprocess the data to retrieve more spectral information from acquired color images. Though the accuracy has improved, the added operations often require professional interventions that need to be accomplished off-line. In this case, smartphone is simply used as a data collection unit for experts rather than ready-to-use customer device, which challenges its usefulness to serve the general public.

Multispectral imaging, in which light intensity is measured in more than the three spectral bands (e.g., red, green, and blue) typically detected by consumer-grade image sensors such as those present in smartphones, is capable of maximally recording the spectral information of subjects. Thus, special-purpose multispectral image sensors are widely used in conducting life science research and contributing to public healthcare services. Realizing this technique on smartphones would create another space for exploitation to benefit our community, given the large user base, high usage frequency and low cost. However, smartphones are equipped with low-dimensional color space image sensors, and not multispectral image sensors.

In some embodiments of the present disclosure, a smartphone with a low-dimensional color space image sensor (e.g., an RGB camera) is used to generate a high-dimensional (e.g., 27-channel) multispectral data cube spanning a range of the visible spectrum expected to contain the peaks and troughs of dominant chromophores in images (e.g., from 420 to 680 nm in a step width of 10 nm, to cover bilirubin and hemoglobin in scleral tissue in the bulbar conjunctiva region) from a single snapshot. From the multispectral data cube, embodiments of the present disclosure provide multiple functions to estimate corresponding measurements of light-emitting compounds such as chromphores or fluorophores, including but not limited to hemoglobin, pigmentation, melanin, porphyrin, bilirubin, or bacteria.

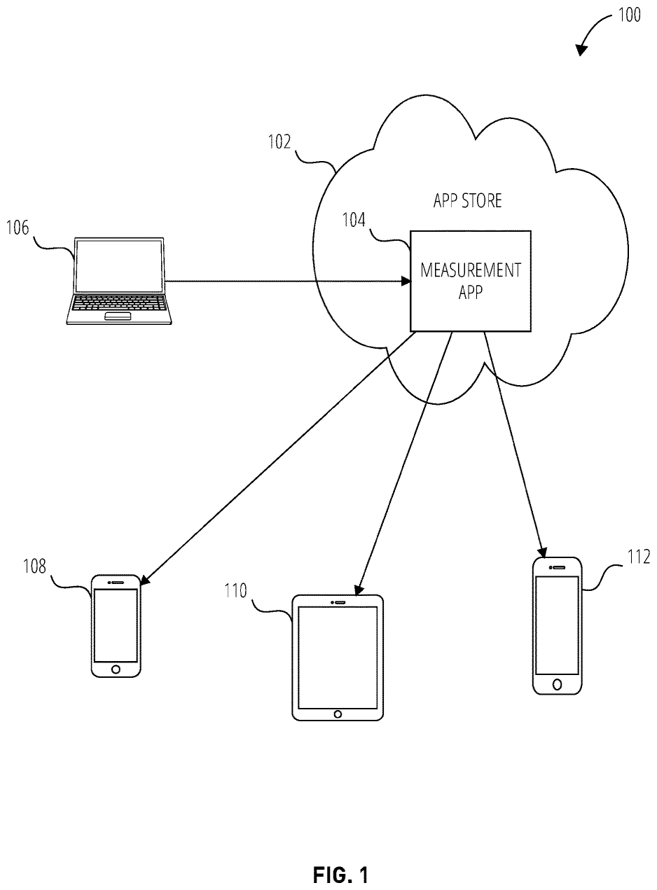

FIG. 1 is a schematic illustration of a non-limiting example embodiment of a system for enabling measurement computing systems to generate predicted measurements of light-emitting compounds according to various aspects of the present disclosure. In the system 100, a light-emitting compound measurement app 104 is created using a training computing system 106 and published on an app store 102, such as the Apple App Store, the Google Play store, Amazon Appstore, BlackBerry World, Huawei AppGallery, Microsoft Store, Samsung Galaxy Store, or another app store configured to provide downloadable applications for computing devices.

In some embodiments, the training computing system 106 is used to generate transformation matrices that are incorporated into the light-emitting compound measurement app 104. Each transformation matrix is generated to allow measurement computing systems having a particular hardware configuration to convert low-color space images captured by a low-dimensional color space camera of the measurement computing system to be converted into multispectral data cubes. By incorporating multiple transformation matrices into the light-emitting compound measurement app 104, a single light-emitting compound measurement app 104 can be used with multiple different hardware configurations, such as a first measurement computing system 108, a second measurement computing system 110, and a third measurement computing system 112. Each of the illustrated first measurement computing systems 108, 110, 112 may be different models of measurement computing systems (e.g., a Google Pixel smartphone vs a Samsung Galaxy smartphone vs a Samsung Galaxy Tab tablet, etc.), different generations of measurement computing systems of a given model (e.g., an iPhone 13 vs an iPhone 14 vs an iPhone 15, etc.), or any other measurement computing systems that otherwise have different hardware configurations such as different illumination sources and/or different low-dimensional color space cameras yet that download applications from the app store 102.

In some embodiments, the training computing system 106 is also used to train machine learning models that are incorporated into the light-emitting compound measurement app 104. The machine learning models are trained to accept values from multispectral data cubes as input and to generate predicted measurements of light-emitting compounds as output. As discussed in further detail below, an ensemble of machine learning models may be trained in order to increase the accuracy of the predicted measurements generated by the light-emitting compound measurement app 104.

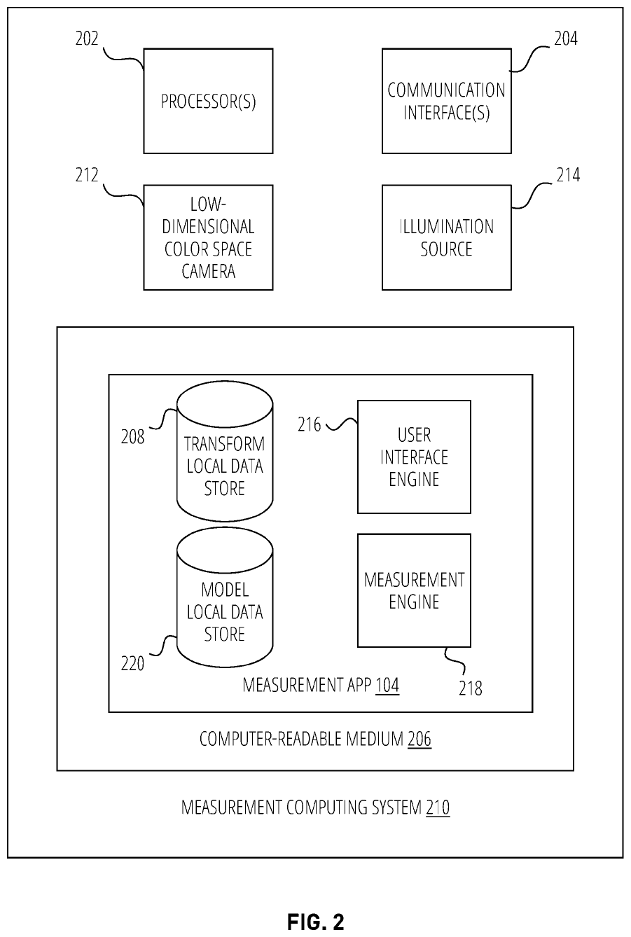

FIG. 2 is a block diagram that illustrates aspects of a non-limiting example embodiment of a measurement computing system according to various aspects of the present disclosure. While in many embodiments, the illustrated measurement computing system 210 may be implemented by a smartphone, tablet, or other mobile computing device, in other embodiments the illustrated measurement computing system 210 may be implemented by any computing device or collection of computing devices, including but not limited to a desktop computing device, a laptop computing device, a mobile computing device, a server computing device, a computing device of a cloud computing system, and/or combinations thereof. The measurement computing system 210 is configured to capture low-color space images of subjects, generate multispectral data cubes based on the low-color space images, and generate predicted measurements of light-emitting compounds based on values from the multispectral data cubes.

As shown, the measurement computing system 210 includes one or more processors 202, one or more communication interfaces 204, a low-dimensional color space camera 212, an illumination source 214, and a computer-readable medium 206.

In some embodiments, the processors 202 may include any suitable type of general-purpose computer processor. In some embodiments, the processors 202 may include one or more special-purpose computer processors or AI accelerators optimized for specific computing tasks, including but not limited to graphical processing units (GPUs), vision processing units (VPTs), and tensor processing units (TPUs).

In some embodiments, the communication interfaces 204 include one or more hardware and or software interfaces suitable for providing communication links between components. The communication interfaces 204 may support one or more wired communication technologies (including but not limited to Ethernet, FireWire, and USB), one or more wireless communication technologies (including but not limited to Wi-Fi, WiMAX, Bluetooth, 2G, 3G, 4G, 5G, and LTE), and/or combinations thereof.

In some embodiments, the low-dimensional color space camera 212 is a camera incorporated into a housing of the measurement computing system 210, such as a camera of a smartphone, tablet, or other mobile computing device, and as configured to capture information in a low-dimensional color space including but not limited to an RGB color space. Typically, the low-dimensional color space camera 212 is capable of capturing images in a relatively high resolution, such as 3264×2448 pixels. In other embodiments, any low-dimensional color space camera 212 capable of capturing images in a low-dimensional color space may be used. As used herein, the term “low-dimensional color space” refers to color information that is divided into three spectral channels, color bands, or wavelength bands, and the term “RGB” may be used interchangeably with the term “low-dimensional.” Though a red-green-blue (RGB) color space is discussed primarily herein as the low-dimensional color space, one will note that other low-dimensional color spaces may be used without departing from the scope of the present disclosure. For example, instead of an RGB color space, some embodiments of the present disclosure may use a CMYK color space, a YIQ color space, a YPbPr color space, a YCbCr color space, an HSV color space, an HSL color space, a TSL color space, a CIEXYZ color space, an sRGB color space, an L*A*B color space, or an ICtCp color space.

In some embodiments, the illumination source 214 is incorporated into the housing of the measurement computing system 210, such as a flashlight of a smartphone, tablet, or other mobile computing device. In some embodiments, the illumination source 214 may be separate from a housing of the measurement computing system 210, such as overhead lighting or studio lighting of a predetermined color temperature.

Typically, while measurement computing systems 210 of the same model, generation, etc. will have low-dimensional color space cameras 212 and illumination sources 214 of matching performance, measurement computing systems 210 of different models and/or generations will use low-dimensional color space cameras 212 and/or illumination sources 214 having different performance. In other words, the illumination sources 214 may produce illumination of different color temperature and/or intensity, and the low-dimensional color space cameras 212 may capture images at different resolutions, different color sensitivities, different spectral ranges, etc. As such, technical solutions are desired for the technical problem of accurately generating predicted measurements with a single light-emitting compound measurement app 104 on multiple measurement computing systems 210 having different performance characteristics.

As shown, the computer-readable medium 206 has stored thereon a light-emitting compound measurement app 104. The light-emitting compound measurement app 104 includes a transform local data store 208, a model local data store 220, and logic that, in response to execution by the one or more processors 202, causes the measurement computing system 210 to provide a a user interface engine 216 and a measurement engine 218.

As used herein, “computer-readable medium” refers to a removable or nonremovable device that implements any technology capable of storing information in a volatile or non-volatile manner to be read by a processor of a computing device, including but not limited to: a hard drive; a flash memory; a solid state drive; random-access memory (RAM); read-only memory (ROM); a CD-ROM, a DVD, or other disk storage; a magnetic cassette; a magnetic tape; and a magnetic disk storage.

In some embodiments, the transform local data store 208 is configured to store transformation matrices for a plurality of different hardware configurations usable as a measurement computing system 210, including the given measurement computing system 210 in which the transform local data store 208 is present. In some embodiments, the model local data store 220 is configured to store machine learning models trained to generate predicted measurements based on values retrieved from multispectral data cubes. In some embodiments, the user interface engine 216 is configured to provide an interface in which a user may select an appropriate transformation matrix to be used, to select a region of interest from an image, and/or perform other configuration tasks. In some embodiments, the measurement engine 218 is configured to use the transformation matrix to generate a multispectral data cube based on a low-color space image captured by the low-dimensional color space camera 212, and to provide values from the multispectral data cube as input to one or more machine learning models from the model local data store 220 to generate predicted measurements of a light-emitting compound.

Further description of the configuration of each of these components is provided below.

As used herein, “engine” refers to logic embodied in hardware or software instructions, which can be written in one or more programming languages, including but not limited to C, C++, C#, COBOL, JAVA™, PHP, Perl, HTML, CSS, Javascript, VBScript, ASPX, Go, and Python. An engine may be compiled into executable programs or written in interpreted programming languages. Software engines may be callable from other engines or from themselves. Generally, the engines described herein refer to logical modules that can be merged with other engines, or can be divided into sub-engines. The engines can be implemented by logic stored in any type of computer-readable medium or computer storage device and be stored on and executed by one or more general purpose computers, thus creating a special purpose computer configured to provide the engine or the functionality thereof. The engines can be implemented by logic programmed into an application-specific integrated circuit (ASIC), a field-programmable gate array (FPGA), or another hardware device.

As used herein, “data store” refers to any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, such as a hard disk drive, a flash memory, RAM, ROM, or any other type of computer-readable storage medium. One of ordinary skill in the art will recognize that separate data store described herein may be combined into a single data store, and/or a single data store described herein may be separated into multiple data store, without departing from the scope of the present disclosure. Further, as used herein, a “local data store” is a type of data store that is present on a computer-readable medium of a given computing device that is also executing an engine that is accessing the local data store.

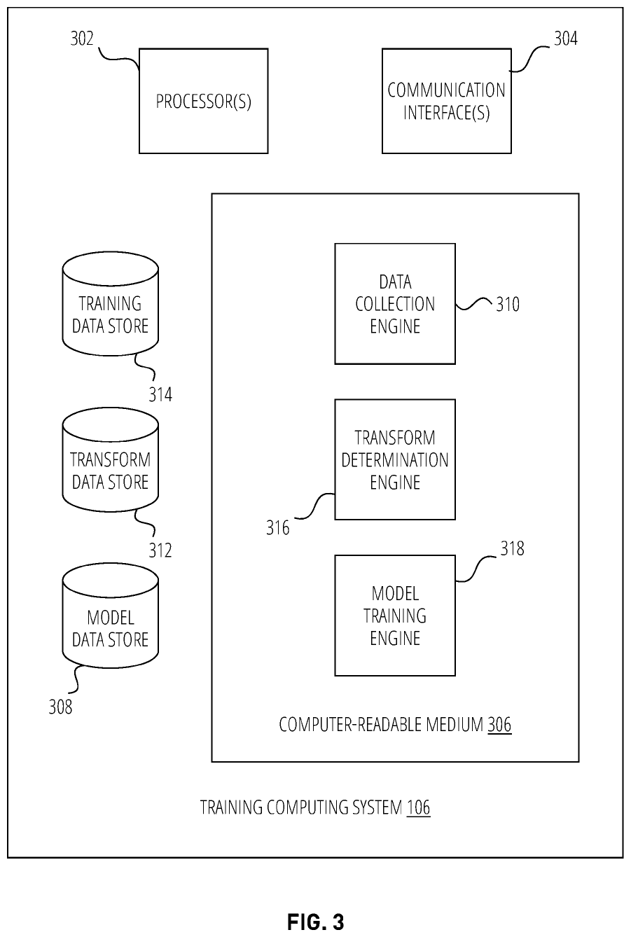

FIG. 3 is a block diagram that illustrates aspects of a non-limiting example embodiment of a computing system according to various aspects of the present disclosure. The illustrated training computing system 106 may be implemented by any computing device or collection of computing devices, including but not limited to a desktop computing device, a laptop computing device, a mobile computing device, a server computing device, a computing device of a cloud computing system, and/or combinations thereof. In some embodiments, the training computing system 106 is configured to obtain training data and to use the training data to generate transformation matrices for a plurality of different types of measurement computing systems 210. In some embodiments, the training computing system 106 is also configured to obtain training data and to use the training data to train one or more machine learning models to generate measurement predictions. In some embodiments, the training computing system 106 is also configured to incorporate the transformation matrices and/or the machine learning models into the light-emitting compound measurement app 104 prior to publication to the app store 102.

As shown, the training computing system 106 includes one or more processors 302, one or more communication interfaces 304, a training data store 314, a transform data store 312, a model data store 308, and a computer-readable medium 306.

In some embodiments, the processors 302 may include any suitable type of general-purpose computer processor. In some embodiments, the processors 302 may include one or more special-purpose computer processors or AI accelerators optimized for specific computing tasks, including but not limited to graphical processing units (GPUs), vision processing units (VPTs), and tensor processing units (TPUs).

In some embodiments, the communication interfaces 304 include one or more hardware and or software interfaces suitable for providing communication links between components. The communication interfaces 304 may support one or more wired communication technologies (including but not limited to Ethernet, FireWire, and USB), one or more wireless communication technologies (including but not limited to Wi-Fi, WiMAX, Bluetooth, 2G, 3G, 4G, 5G, and LTE), and/or combinations thereof.

As shown, the computer-readable medium 306 has stored thereon logic that, in response to execution by the one or more processors 302, cause the training computing system 106 to provide a data collection engine 310, a transform determination engine 316, and a model training engine 318.

In some embodiments, the data collection engine 310 is configured to collect data usable to determine transformation matrices and to train the machine learning models to generate predicted measurements, and to store such data in the training data store 314. In some embodiments, the transform determination engine 316 is configured to use the training data to determine the transformation matrices, and to store the determined transformation matrices in the transform data store 312. In some embodiments, the model training engine 318 is configured to use the training data to train one or more machine learning models, and to store the machine learning models in the model data store 308.

Further description of the configuration of each of these components is provided below.

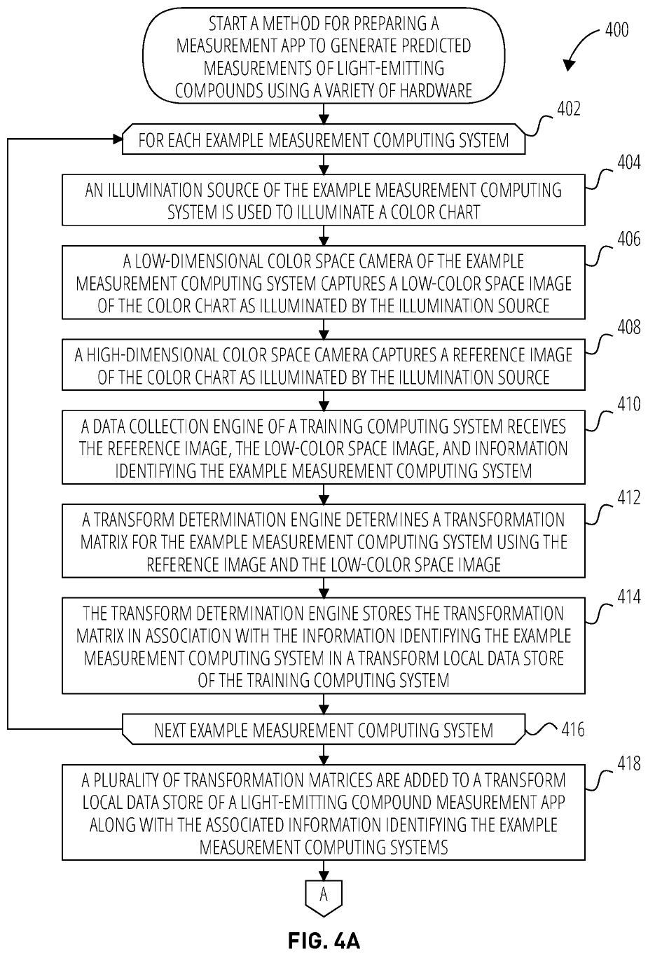

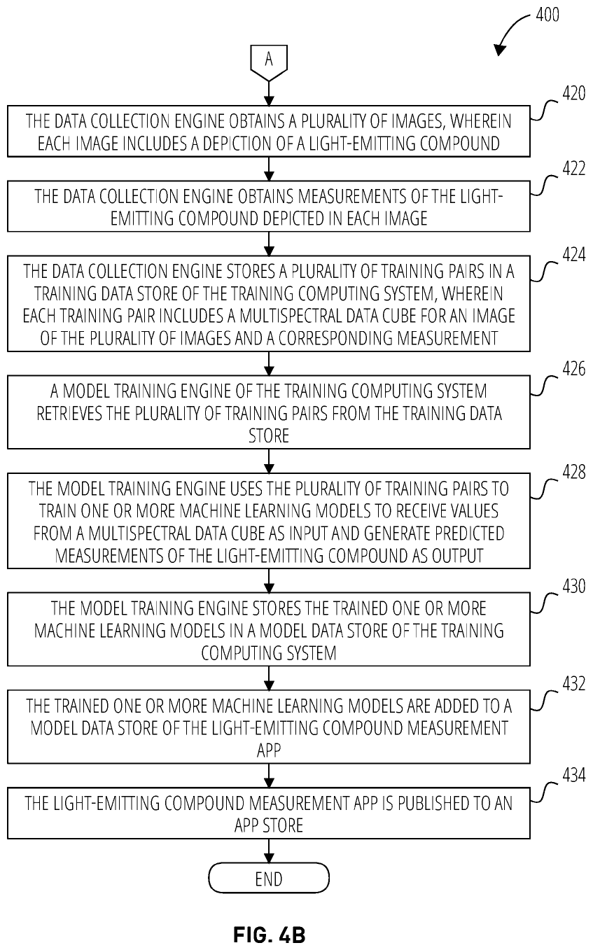

FIG. 4A-FIG. 4B are a flowchart that illustrates a non-limiting example embodiment of a method for preparing a light-emitting compound measurement app to generate predicted measurements of light-emitting compounds using a variety of hardware according to various aspects of the present disclosure. In the method 400, a training computing system 106 prepares transformation matrices and machine learning models, and incorporates the prepared transformation matrices and machine learning models into the light-emitting compound measurement app 104 for use by a variety of measurement computing systems 210 with different hardware.

From a start block, the method 400 advances to a for-loop defined between a for-loop start block 402 and for-loop end block 416, wherein a plurality of different example measurement computing systems 210 are analyzed for use with the light-emitting compound measurement app 104. Each example measurement computing system 210 may stand in for other measurement computing systems 210 having matching hardware characteristics (e.g., an iPhone 14 Plus may be used as an example measurement computing system 210 to represent other iPhone 14 Pluses, a Google Pixel 8 Pro may be used as an example measurement computing system 210 to represent other Google Pixel 8 Pros, etc.).

From the for-loop start block 402, the method 400 advances to block 404, where an illumination source 214 of the example measurement computing system 210 is used to illuminate a color chart. In some embodiments, the room or other environment in which the color chart is situated is kept dark other than the illumination source 214 so as to isolate reflections of the illumination source 214 from other ambient light sources of differing spectral characteristics.

In some embodiments, the color chart includes a plurality of different colors to be illuminated and imaged. In some embodiments, the color chart may include one hundred different colors spaced throughout a visible spectrum using any suitable technique, including but not limited to being randomly spaced and being evenly spaced. In some embodiments, a smaller or greater number of colors may be used. In some embodiments, the color chart may also include a portion from which spectral characteristics of the illumination source may be determined. As a non-limiting example, the color chart may include a polymer white diffuser standard, such as a standard of 95% reflectance manufactured by SphereOptics GmbH. In some embodiments, such a standard from which spectral characteristics of the illumination source may be separate from the color chart.

At block 406, a low-dimensional color space camera 212 of the example measurement computing system 210 captures a low-color space image of the color chart as illuminated by the illumination source, and at block 408, a high-dimensional color space camera captures a reference image of the color chart as illuminated by the illumination source 214. In some embodiments, the high-dimensional color space camera is any camera capable of capturing images in a high-dimensional color space. As used herein, the term “high-dimensional color space” refers to color information that is divided into more than three spectral channels, color bands, or wavelength bands, and the term “high-dimensional color space” may be used interchangeably with the term “hyperspectral.” One non-limiting example of a high-dimensional color space camera is a MQ022HG-IM-SM4X4-VIS, from XIMEA, Germany, with 16 spectral channels.

In some embodiments, wavelength information may be obtained from the color chart using some other technique, including but not limited to measurement by a spectrometer. In some embodiments, the color chart may include colors that represent known values (that is, the wavelength information associated with each color block is known). In such embodiments, capturing the reference image may be skipped, and the known values for the color chart may be used.

At block 410, a data collection engine 310 of a training computing system 106 receives the reference image, the low-color space image, and information identifying the example measurement computing system 210. In some embodiments, the data collection engine 310 controls the illumination source 214, the low-dimensional color space camera 212, and the high-dimensional color space camera in order to collect the information. The information identifying the example measurement computing system 210 may be any suitable information for identifying the combination of hardware used as the illumination source 214 and the low-dimensional color space camera 212. In some embodiments, a model name (e.g., “iPhone 14 Plus,” “Google Pixel 8 Pro,” etc.), a model identifier number, a serial number, or other identifier of the example measurement computing system 210 as a whole may be used as the information identifying the example measurement computing system 210. In some embodiments, a model name, serial number, or other identifying information of the illumination source 214 component and/or low-dimensional color space camera 212 component itself may be used as the information identifying the example measurement computing system 210. In some embodiments, the information identifying the example measurement computing system 210 may be provided via a user interface. In some embodiments, the information identifying the example measurement computing system 210 may be queried automatically from the example measurement computing system 210 by the data collection engine 310.

At block 412, a transform determination engine 316 determines a transformation matrix for the example measurement computing system 210 using the reference image and the low-color space image. Any suitable transformation matrix that can transform RGB images into hyperspectral images, such as a Wiener estimation matrix, may be used.

When a reference image is captured by the high-dimensional color space camera and color reference information is extracted, the response of each subchannel of n subchannels is depicted as:

$${V}_{{c}^{′}}^{′} = \int l ( λ ) γ ( λ ) {f}_{{c}^{′}} ( λ ) {s}^{′} ( λ ) dλ = \int ( {m}_{{c}^{′}}^{′} ( λ ) γ ( λ ) d λ$$

where V′_{c′} is the response of c'th subchannel (c=1,2,3, . . . , n), f_{c′}(λ) is the spectral transmittance of the filter in c'th subchannel, s′(λ) is the spectral sensitivity. m′_{c′}(λ) is the product of l(λ), f_{c}(λ) and s(λ), which is the spectral responsivity of each subchannel in the high-dimensional color space camera. The matrix form of the equation above is then expressed as:

$${V}^{′} = {M}^{′} γ$$

where V′ is the vector of hyperspectral camera response, and M′ is the matrix of spectral responsivity in the high-dimensional color space camera. To reconstruct high-dimensional color space information from low-dimensional color space information, we assume the reconstruction matrix is W. The process is expressed as:

$${\tilde{V}}^{′} = WV$$

where \tilde{V}′ is the reconstructed image having high-dimensional color space information. To ensure the accuracy of reconstruction, the minimum square error between the reconstructed high-dimensional color space information and the original reference image should be minimized. The minimum square error is calculated as:

$${e = \text{<(} {V}^{′} - {\tilde{V}}^{′} )}^{t} ( {V}^{′} - {\tilde{V}}^{′} \text{)>} = {< V}^{′t} {V}^{′} > - W {< V}^{′ t} V > - {W}^{t} {< V}^{t} {V}^{′} > + {W}^{t} W {< V}^{′ t} {V}^{′} >$$

When the partial derivative of e with respect to W is zero, the minimum square error is minimized, expressed

$$\frac{\partial e}{\partial W} = {\text{-<} V}^{′ t} V > + {W}^{t} {\text{<V}}^{t} \text{V>} = 0$$

The transformation matrix is derived as:

$$W = {< V}^{′} {V}^{t} \text{><} V {V}^{t} {>}^{- 1}$$

where W is an ensemble-averaging operator, <V′V^{t}> is the correlation matrix between the hyperspectral response and low-dimensional color space camera response, and <VV^{t}> is the autocorrelation matrix of the low-dimensional color space camera response. Further details regarding determination of a transformation matrix are provided in commonly owned, co-pending U.S. Pre-Grant Publication No. 2022/0329767, the entire disclosure of which is hereby incorporated by reference herein for all purposes.

At block 414, the transform determination engine 316 stores the transformation matrix in association with the information identifying the example measurement computing system 210 in a transform data store 312 of the training computing system 106.

The method 400 then advances to the for-loop end block 416. If further example measurement computing systems 210 remain to be processed, then the method 400 returns from for-loop end block 416 to for-loop start block 402 to process the next example measurement computing system 210. Otherwise, if all of the example measurement computing systems 210 have been processed, then the method 400 proceeds from for-loop end block 416 to block 418.

At block 418, a plurality of transformation matrices are added to a transform local data store 208 of a light-emitting compound measurement app 104 along with the associated information identifying the example measurement computing systems 210. In some embodiments, the light-emitting compound measurement app 104 may be developed using the training computing system 106, and the plurality of transformation matrices may be added to the transform local data store 208 prior to publication of the light-emitting compound measurement app 104 at the app store 102. The method 400 then proceeds to a continuation terminal (“terminal A”).

From terminal A (FIG. 4B), the method 400 proceeds to block 420, where the data collection engine 310 obtains a plurality of images, wherein each image includes a depiction of a light-emitting compound, and at block 422, the data collection engine 310 obtains measurements of the light-emitting compound depicted in each image. The image may be collected by one of the example measurement computing systems 210 for which a transformation matrix was determined earlier in the method 400.

The images and measurements of the light-emitting compound may be obtained in any suitable manner. For example, in some embodiments, an artificially produced target with a known concentration of the light-emitting compound may be created and imaged. In one non-limiting example, such artificial targets, or “phantoms,” may be generated to represent varying concentrations of a light-emitting compound such as bilirubin. A phantom may be created by weighing ten grams of agar powder and adding it to one hundred mL of deionized water. The mixture may be maintained in a water bath at one hundred degrees Celsius under continuous mechanical stirring. Then, 0.5 g of titanium dioxide powder may be added into the solution to simulate the optical properties of a background sclera. After stirring for five minutes, different amounts of bilirubin powders may be added to prepare phantoms with different bilirubin concentrations (e.g., 0.00, 0.23, 0.47, 0.94, 1.88, 3.75, 7.50, 15.00, and 30.00 mg/dL). After stirring for another ten minutes, the mixture may be cooled to 47 degrees Celsius under continuous stirring before being emptied into a petri dish for cooling and forming. Images may then be captured of the phantoms, and the known bilirubin concentrations may be used as the measurements.

As another example, in some embodiments, images of subjects with a region of interest that represents the light-emitting compound (e.g., a portion of a sclera) may be collected, and the measurement of the light-emitting compound may be obtained from a test performed on the subject. For example, to determine a blood bilirubin level, a blood sample (e.g., a 3 mL blood sample drawn from a subcutaneous vein in the arm of the subject) may be obtained and analyzed to determine the blood bilirubin level (e.g., via a diazo method using the Beckmann biochemical analysis system from Beckman Coulter Inc.).

At block 424, the data collection engine 310 stores a plurality of training pairs in a training data store 314 of the training computing system 106, wherein each training pair includes a multispectral data cube for an image of the plurality of images and a corresponding measurement. The measurement of a training pair is used as a label indicating a value to be learned for the corresponding multispectral data cube of the training pair. The multispectral data cube for the image may be determined using a transformation matrix as described above. In some embodiments, the training pair may also store an indication of a region of interest within the multispectral data cube. In some embodiments, the multispectral data cube may be limited to the region of interest of the image, and may exclude values for areas of the image outside of the region of interest.

At block 426, a model training engine 318 of the training computing system 106 retrieves the plurality of training pairs from the training data store 314, and at block 428, the model training engine 318 uses the plurality of training pairs to train one or more machine learning models to receive values from a multispectral data cube as input and generate predicted measurements of the light-emitting compound as output. Any suitable architectures may be used for the one or more machine learning models. Examples of suitable architectures include, but are not limited to, an artificial neural network (ANN) architecture, a support vector machine (SVM) architecture, a k-nearest neighbors (KNN) architecture, and a random forest (RF) architecture. In some embodiments, one of each of an ANN model, an SVM model, a KNN model, and an RF model may be trained. The one or more models may be trained using any suitable technique, including but not limited to gradient descent techniques. While described as “one or more” machine learning models, increased accuracy may be obtained in some embodiments by using two or more machine learning models as an ensemble of models, as multiple models may be able to compensate for weaknesses in predictions generated by any one type of model.

At block 430, the model training engine 318 stores the trained one or more machine learning models in a model data store 308 of the training computing system 106. At block 432, the trained one or more machine learning models are added to a model local data store 220 of the light-emitting compound measurement app 104. As with the transformation matrices, the machine learning models may be added to the model local data store 220 at the training computing system 106 prior to the publication of the light-emitting compound measurement app 104 at the app store 102.

At block 434, the light-emitting compound measurement app 104 is published to an app store 102. After having been published, the light-emitting compound measurement app 104 may be downloaded and installed by measurement computing systems 210. The method 400 then proceeds to an end block and terminates.

As illustrated, the method 400 trains machine learning models to detect a single light-emitting compound. In some embodiments, multiple sets of machine learning models may be trained to detect different light-emitting compounds. For example, a first set of machine learning models may be trained to predict a blood bilirubin level, while a second set of machine learning models may be trained to predict a hemoglobin level, and so on. All of the machine learning models may be stored in the model local data store 220 once trained, and may be selected by a user as described in further detail below.

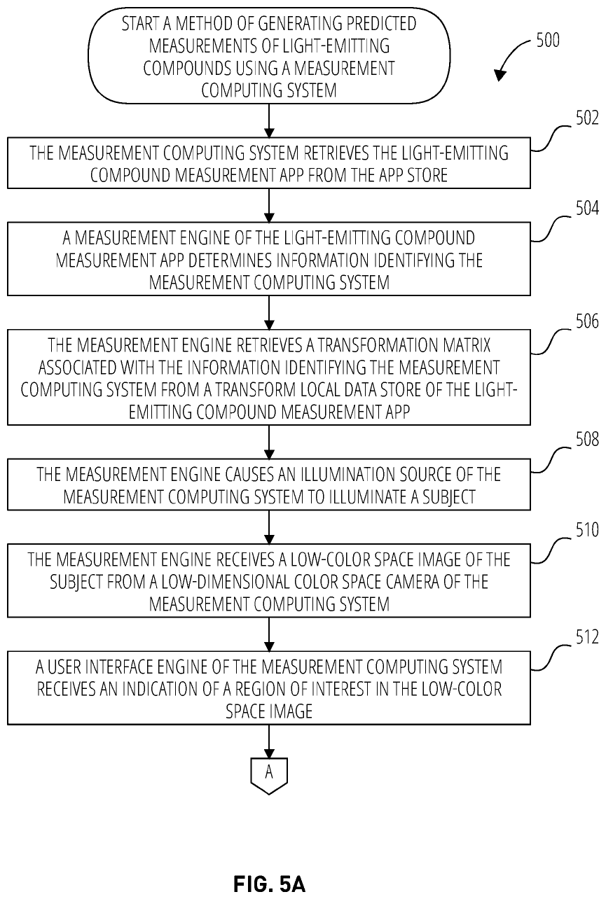

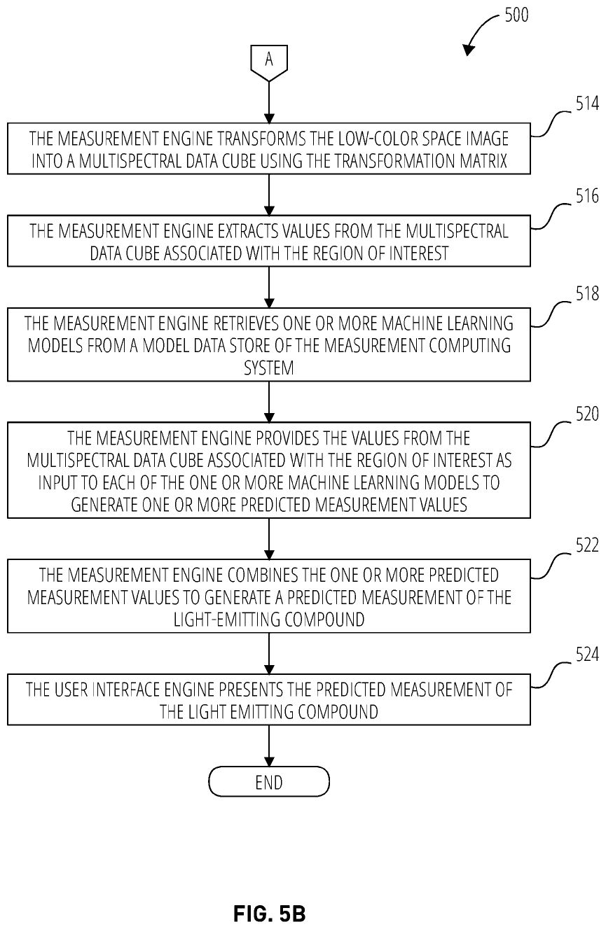

FIG. 5A-FIG. 5B are a flowchart that illustrates a non-limiting example embodiment of a method of generating predicted measurements of light-emitting compounds using a measurement computing system according to various aspects of the present disclosure. In the method 500, a measurement computing system 210 uses the light-emitting compound measurement app 104 configured by the method 400 discussed above to generate predicted measurements.

From a start block, the method 500 advances to block 502, where the measurement computing system 210 retrieves the light-emitting compound measurement app 104 from the app store 102. The measurement computing system 210 downloads the light-emitting compound measurement app 104 from the app store 102 and installs it using techniques that are well known to those of ordinary skill in the art, and so are not described in further detail here for the sake of brevity.

At block 504, a measurement engine 218 of the light-emitting compound measurement app 104 determines information identifying the measurement computing system 210. As with the determination of the information identifying the measurement computing system 210 at block 410, any suitable information that identifies the hardware of the measurement computing system 210 and allows an appropriate transformation matrix to be identified may be used, and may be determined using any suitable technique. For example, in some embodiments, the measurement engine 218 may query an operating system of the measurement computing system 210 in order to automatically retrieve the information. As another example, in some embodiments, a user interface engine 216 of the light-emitting compound measurement app 104 may present a configuration interface that allows a user to specify the information.

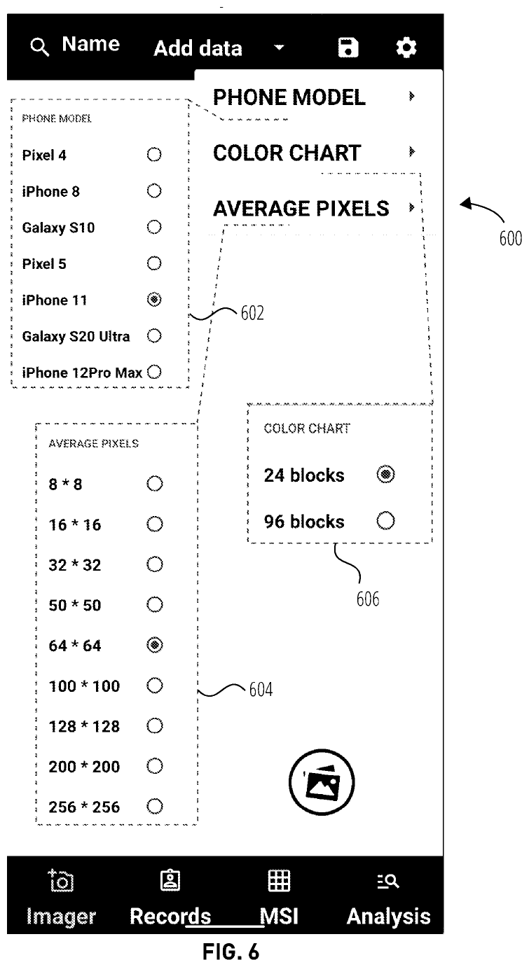

FIG. 6 is an illustration of a non-limiting example embodiment of a configuration interface for the light-emitting compound measurement app according to various aspects of the present disclosure. As shown, the configuration interface 600 includes a list of models 602 that includes a plurality of different models of measurement computing systems 210 for which a transformation matrix is stored within the transform local data store 208 of the light-emitting compound measurement app 104. A user may select the appropriate model from the list of models 602, thus indicating the information identifying the measurement computing system 210.

The configuration interface 600 also includes various other interface elements for configuring other portions of the light-emitting compound measurement app 104. As shown, the configuration interface 600 includes a list of sizes 604 and a list of color charts 606. The list of sizes 604 allows the user to select a size for a region of interest, that will be discussed in further detail below. Though each of the sizes in the list of sizes 604 is square, in some embodiments, the list of sizes 604 (or another interface element) may allow the shape of the region of interest to be changed (e.g., different aspect ratios for rectangular regions, circles or other polygons instead of rectangles, etc.).

The list of color charts 606 allows the user to select a pre-determined color chart to be used to re-calibrate the light-emitting compound measurement app 104. In some embodiments, the measurement computing system 210 may be used under controlled lighting conditions, such as low-light conditions in which the illumination source 214 is the dominant illuminant of the subject, and the stored transformation matrix produces accurate results. In such embodiments, the list of color charts 606 may not be provided. In other embodiments, the measurement computing system 210 may be used in less-controlled lighting conditions. In such embodiments, a user may select a color chart from the list of color charts 606 to be used for re-calibration.

To support re-calibration, the training computing system 106 may store expected low-dimensional color space values for one or more standard color charts (e.g., a 24-block X-rite ColorChecker Classic/Passport/Mini/Nano color chart; or a 96-block X-rite ColorChecker Digital SG color chart) in the transform local data store 208 that were captured using the same illumination source 214 used to determine the transformation matrix associated with the information identifying the measurement computing system 210. The measurement engine 218 may capture a low-color space image of the selected color chart under the same lighting conditions to be used to image the subject (potentially from the same image in which the subject appears), and may use the expected low-dimensional color space values to apply a correction to the low-color space image in order make the low-color space image match the illumination source used to create the transformation matrix.

Returning to FIG. 5A, the method 500 proceeds to block 506, where the measurement engine 218 retrieves a transformation matrix associated with the information identifying the measurement computing system 210 from a transform local data store 208 of the light-emitting compound measurement app 104. At block 508, the measurement engine 218 causes an illumination source 214 of the measurement computing system 210 to illuminate a subject. In one non-limiting example embodiment wherein the illumination source 214 is a flashlight of the measurement computing system 210, the measurement engine 218 may cause the flashlight to be turned on for at least a duration of time during which the low-color space image is captured by the low-dimensional color space camera 212.

At block 510, the measurement engine 218 receives a low-color space image of the subject from a low-dimensional color space camera 212 of the measurement computing system 210. In some embodiments, the low-color space image may be provided directly to the measurement engine 218 by an operating system of the measurement computing system 210. In some embodiments, the low-color space image may be retrieved from a camera roll or other storage of the measurement computing system 210 after having been captured by the low-dimensional color space camera 212 and stored on the measurement computing system 210.

At block 512, the measurement engine 218 transforms the low-color space image into a multispectral data cube using the transformation matrix. In some embodiments, the measurement engine 218 may perform a pixel-by-pixel transformation of the low-color space image using the transformation matrix to determine values of the spectral bands in the high-dimensional color space for each pixel of the multispectral data cube from the pixels of the low-color space image.

The method 500 then proceeds to a continuation terminal (“terminal A”). From terminal A (FIG. 5B), the method 500 proceeds to block 514, where a user interface engine 216 of the light-emitting compound measurement app 104 receives an indication of a region of interest. In some embodiments, the user interface engine 216 may present the low-color space image or a portion of the multispectral data cube (i.e., an image representing one or more spectral bands from the multispectral data cube), and may allow the user to indicate the region of interest. The region of interest is a portion of the low-color space image that shows a portion of the subject from which the light-emitting compound can be measured. As a non-limiting example, to generate a predicted measurement of a blood bilirubin level, a portion of the image that depicts the sclera may be used. A size and/or shape of the region of interest may be specified in a separate configuration interface 600 as illustrated in FIG. 6.

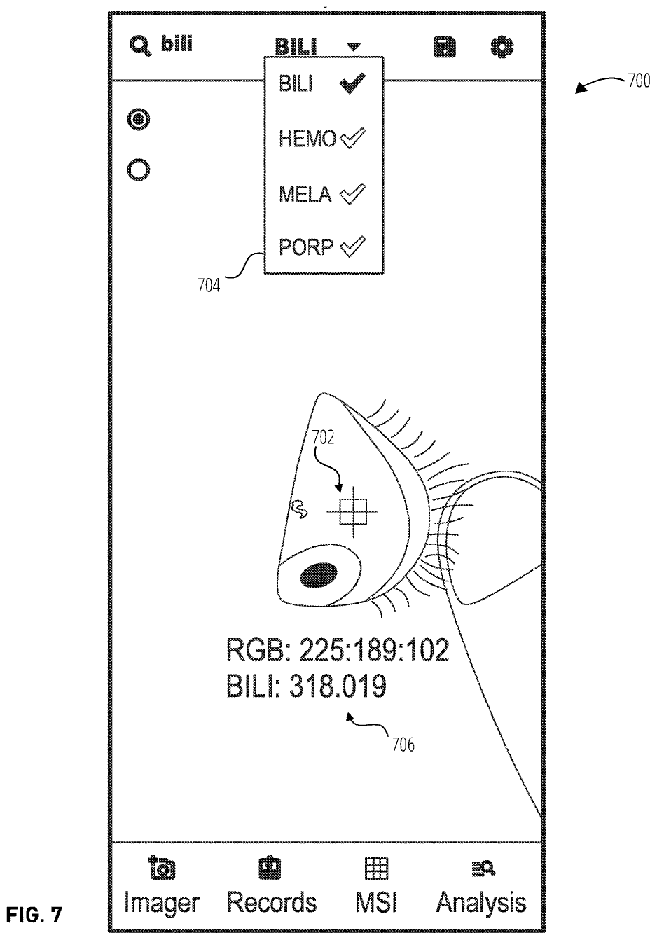

FIG. 7 is an illustration of a non-limiting example embodiment of an interface for specifying a region of interest according to various aspects of the present disclosure. As shown, a region of interest indicator 702 may be dragged to the portion of the image that shows the area of the subject to be sampled. In some embodiments, a user may initially cause the region of interest indicator 702 to be positioned by tapping on the desired location. The illustrated embodiment shows the region of interest indicator 702 positioned to sample the sclera of an eye of the subject, though in other embodiments, other regions may be sampled.

In some embodiments, the region of interest interface 700 may also include a list of light-emitting compounds 704 for which the light-emitting compound measurement app 104 is configured to measure. The illustrated embodiment shows that the light-emitting compound measurement app 104 is configured to selectively measure a blood bilirubin level (BILI), a hemoglobin level (HEMO), a melanin level (MELA), a porphyrin level (PORP). In some embodiments, the light-emitting compound measurement app 104 may be configured to measure more or fewer light-emitting compounds. In some embodiments, any light-emitting compound that exhibits spectral-specific reflectance properties that are distinguishable from a background, such as chromophores or fluorophores, may be measured.

Returning to FIG. 5B, at block 516, the measurement engine 218 extracts values from the multispectral data cube associated with the region of interest. In some embodiments, pixel values from the two-dimensional region specified by the region of interest in each of the spectral bands of the multispectral data cube may be extracted.

At block 518, the measurement engine 218 retrieves one or more machine learning models from a model local data store 220 of the measurement computing system 210, and at block 520, the measurement engine 218 provides the values from the multispectral data cube associated with the region of interest as input to each of the one or more machine learning models to generate one or more predicted measurement values. In some embodiments, a given machine learning model may generate a separate predicted measurement value for each pixel of the extracted values, and may combine (e.g., average) the separate predictions to create a predicted measurement associated with the given machine learning model. In some embodiments, a given machine learning model may use all of the extracted values to generate a single predicted measurement value.

At block 522, the measurement engine 218 combines the one or more predicted measurement values to generate a predicted measurement of the light-emitting compound. As such, the measurement engine 218 treats the one or more machine learning models as an ensemble of models. Any suitable technique may be used to combine the one or more predicted measurement values. In some embodiments, the predicted measurement values may simply be averaged to generate the predicted measurement of the light-emitting compound. In some embodiments, more complicated techniques may be used. For example, weights for each machine learning models may be determined while training the machine learning models at block 428 of method 400 as illustrated in FIG. 4B, such that some machine learning models more strongly influence the predicted measurement than others.

At block 524, the user interface engine 216 presents the predicted measurement of the light-emitting compound. Any suitable technique for presenting the predicted measurement may be used. In some embodiments, a value for the predicted measurement may be directly displayed on the user interface, such as the predicted measurement 706 illustrated in FIG. 7. In some embodiments, predicted measurements may be used to detect a presence or absence of the associated light-emitting compound in the image, and a mask, overlay, or other presentation that shows the presence or absence of the light-emitting compound may be presented. In some embodiments, instead of a visual presentation, the predicted measurement may be stored for future use, or may be transmitted to another device for further processing.

The method 500 then proceeds to an end block and terminates.

### Results

To show the performance of these techniques, an embodiment of a light-emitting compound measurement app 104 was installed on an unmodified smartphone and used as a bilirubinometer to quantify the sclera pigmentation at the region of bulbar conjunctiva to predict a blood bilirubin level (BBL). In the clinical imaging of three hundred and twenty liver disease (LD) patients, the prediction generated by the light-emitting compound measurement app 104 demonstrated more than 0.9 correlation with the standard invasive clinical testing. To further show the benefits of the light-emitting compound measurement app 104, the prediction using spectrally augmented learning (SAL) as implemented by the light-emitting compound measurement app 104 was compared to RGB-enabled learning (RGBL) using RGB photographs captured by smartphone snapshots without being transformed into a multispectral data cube. Experimental results demonstrated that SAL as implemented by the light-emitting compound measurement app 104 delivers higher prediction quality, efficiency and stability than RGBL, especially when the data feeding was limited. Because the light-emitting compound measurement app 104 does not use customized hardware, the techniques disclosed herein have the potential to be widely distributed in an extremely cost-effective and easy-to-use mode. Providing tests of BBL and other bio-chromophores in this manner would be particularly useful for the users at both resource-limited and homecare settings.

RGB values can be influenced by different illumination conditions and channel sensitivities, which may lead to inconsistent responses under different camera settings. To address this issue, the tested embodiment of the light-emitting compound measurement app 104 provided both default transformation matrices and recalibration options to stabilize the quality of spectral imaging. Some extreme conditions were simulated by adjusting the color temperature and ISO of the camera to challenge this stability. The X-rite ColorChecker Digital SG color chart was used in this evaluation and imaged under different settings for the low-dimensional color space camera 212. The color temperature was increased from 2500K to 9000K with a step width of 500 k. The ISO was set to be 880, 840, 800, 720, 640, 570, 500, 450, 400, 360, 318, 285, 250 and 200, respectively. The RGB values and reflectance spectra of all color blocks in these procedures were recorded by the light-emitting compound measurement app 104. With the color temperature increased from 2500K to 9000K, it was observed the signals in G and B channels remained relatively stable, but that in R channel increased proportionally from the RBG images. In contrast, the light-emitting compound measurement app 104 provided relatively stable signals in all reconstructed reflectance spectral channels despite the change in the color temperature. To quantify the consistency, the standard deviations of signals were calculated in each channel for all color blocks. After normalizing RGB values into the same scale as MSI signals, the averaged standard deviations in RGB channels were calculated to be ˜0.045 and ˜0.070 when changing the color temperature and ISO, respectively. The corresponding standard deviation values in MSI channels were calculated to be ˜0.015 and ˜0.013. Compared with the RGB values, the signals in MSI channels perform much lower standard deviations. These experiments demonstrate that the light-emitting compound measurement app 104 can reconstruct accurate spectral information of the sample with a high consistency under different device conditions and settings.

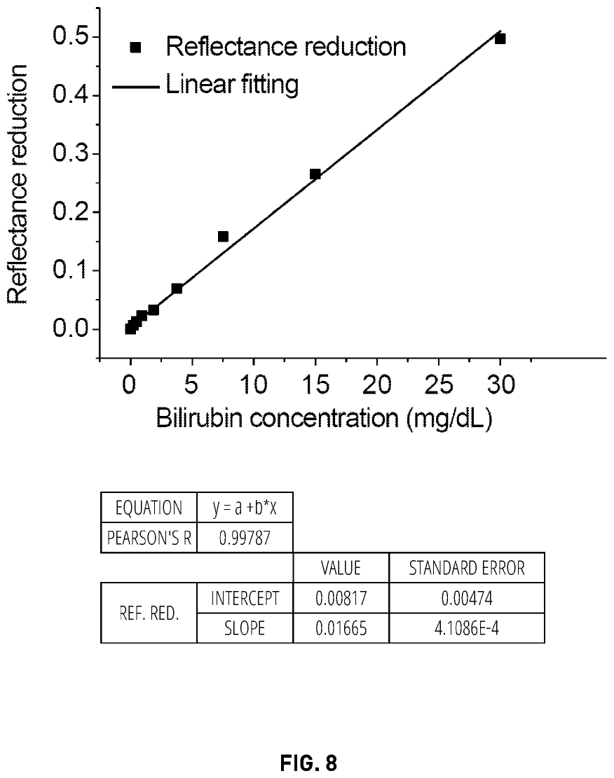

RGB photographs were acquired of phantoms created to represent 0.00, 0.23, 0.47, 0.94, 1.88, 3.75, 7.50, 15.00, and 30.00 mg/dL, and their reflectance spectra were obtained by the light-emitting compound measurement app 104. These spectra were normalized by the reflectance at 680 nm because the absorbance of bilirubin at this wavelength band is negligible. Compared with phantom 1 without bilirubin, other phantoms give lower reflectance around 460 nm and the rate of reduction is similar to that of the concentration. The values of rate reduction at 460 nm were calculated and the points were mapped with their bilirubin concentrations, accordingly, shown in FIG. 8. There is an excellent linear relationship between these two variables, verifying that the light-emitting compound measurement app 104 can be used to detect and quantify the optical absorption of light-emitting compounds such as bilirubin.

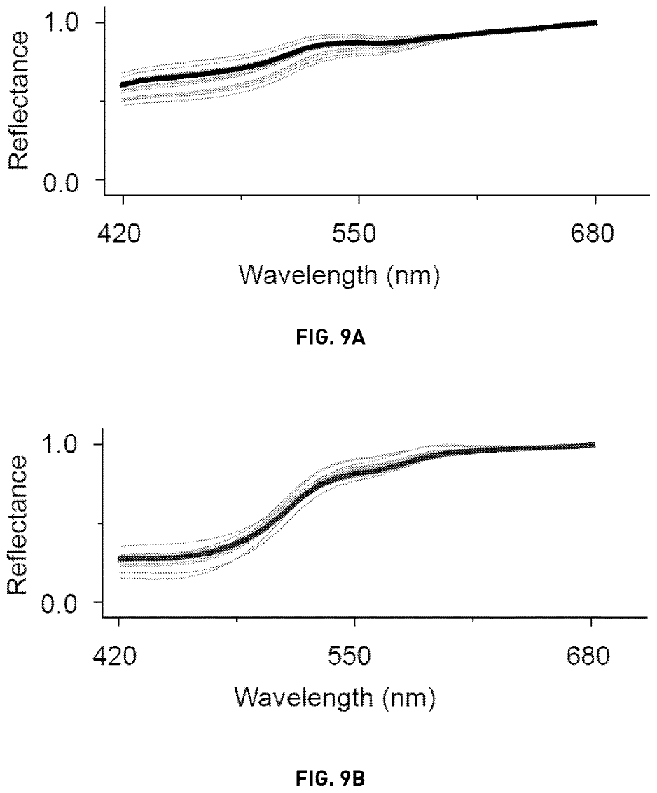

FIG. 9A and FIG. 9B show results of imaging enabled by the light-emitting compound measurement app 104 on the sclera in the anterior segment of eye (bulbar conjunctiva region) in two representative clinical cases. Clinically, BBLs in the patients were measured at 27.0 μmol/L (FIG. 9A) and 368.9 μmol/L (FIG. 9B), respectively. In the wavebands from 420 to 480 nm, the two cases show distinct signal strength differences in the sclera due to different levels of bilirubin concentration. With a further increase of the wavelength, the difference gradually decreases because the absorbance of bilirubin becomes negligible at the longer wavelengths. In the red bands above 650 nm, no significant absorption can be observed in both cases. In each trial, ten snapshots were acquired at different regions of the sclera. From each snapshot, an averaged spectrum from the selected ROI was calculated. The final reflectance spectra were then averaged from these ten measurements, showing as the black curves in FIG. 9A and FIG. 9B. The reflectance spectra also support the above observation that the sclera tissue of the patient with higher BBL shows lower reflectance in wavebands from 420 to 480 nm. Using the captured reflectance spectra, the light-emitting compound measurement app 104 predicted the BBL of these two cases to be 30.5 μmol/L and 380.5 μmol/L, respectively, agreeing well with the clinical testing results.

To generate the predictions of bilirubin concentration from the captured images, an ensemble of machine learning models was trained and used. Machine learning is increasingly applicable in medical context because of its excellent ability to recognize subtle pattern features on datasets. Here, the rich but subtle information due to the light-emitting compounds embedded within the multispectral images acquired by a measurement computing system 210 provide an excellent opportunity to develop a machine learning method to predict the concentration of that compound. Below, measures of accuracy for the models constructed to create this prediction are presented.

Three hundred and twenty patients with LD were enrolled in the study. The subjects show diversities in the gender, age and diagnosis of disorders. RGB photographs and reflectance spectra of sclera, paired with BBL results obtained from clinical blood testing were included in the data set. Except for the yellow pigmentation, the sclera tissue region also shows redness because it is covered by a highly vascularized conjunctiva layer. Considering this multiple-chromophore structure is more complicated than the bilirubin phantom, an ensemble of machine learning algorithms were used to predict BBL instead of using linear regression algorithms. Four established machine learning algorithms, including artificial neural networks (ANN), support vector machines (SVM), k-nearest neighbor (KNN) and random forests (RF), were used. While designed with different rationale and architectures, these four architectures were selected because they represent commonly used machine learning methods and are all appropriate for training regression models. In this way, the generalizability of the augmentation and prediction provided by the light-emitting compound measurement app 104 can be tested. Afterwards, a hybrid regression model was built to combine the outputs of the machine learning models, since hybrid machine learning has the advantages in reducing biases and increasing accuracy.

In three hundred and twenty cases, the model provided an excellent correlation between predictions generated by the light-emitting compound measurement app 104 and clinical BBL measurements, with a R value above 0.90. From the Bland-Altman plots, small limits of agreement (LOA) (+119.90/−117.45 μmol/L) and bias (1.23 μmol/L) were observed. The area under the ROC curve (AUROC) for the BBL prediction performed by the light-emitting compound measurement app 104 was calculated to be 0.97, indicating that the light-emitting compound measurement app 104 and its built-in prediction model can provide a reliable measurement of the BBL by simply taking color photos of the sclera tissue using a measurement computing system 210 such as a smartphone.

To validate the assumption that the multispectral imaging provided by the light-emitting compound measurement app 104 can better predict BBL than conventional RGB smartphone imaging, the quality of prediction was compared using SAL versus RGBL. Besides, given richer information with higher spectral resolution, SAL should also learn quicker than the RGBL model. To validate this point, the prediction performance was tested and compared while reducing the data feeding. In the whole set of three hundred and twenty cases, RGBL produced visually similar plots with SAL, but its Bland-Altman plots indicate a wider LOA (+136.63/−126.57 μmol/L) and bigger bias (5.03 μmol/L). Further, when the sample size was reduced, the stability of SAL prediction remained relatively constant, whilst a deterioration of the RGBL prediction was observed (where the regression curve is seen gradually deviating and the prediction band is becoming wider). The corresponding Bland-Altman plots validated this observation. With the sample size decreased to 25%, the LOA of SAL prediction is +114.22/−107.87 μmol/L, but the LOA of RGBL prediction is +166.69/−148.82 μmol/L. More sample sizes were tested with data resampling percentage changing from 12.5% to 100% with a step width at 12.5% and summarized the values of correlation (R), mean difference (MD) and standard deviation (STD). Overall, the SAL prediction shows higher R, lower MD and STD than RGBL in all groups.

The enhancement of SAL prediction over RGBL is benefited from the multispectral information brought by the light-emitting compound measurement app 104, rather than by a specific design of the prediction model. To demonstrate this point, the quality of predictions using SAL and RGBL implemented by individual ANN, SVM, KNN and RF algorithms was investigated. The input of SAL and RGBL are the spectra saved in the light-emitting compound measurement app 104 and corresponding RGB values of ROIs. To summarize these comparisons, SAL improved the prediction quality to varying degrees, especially with less data feeding. To illustrate this point clearer, the prediction performance of SAL and RGBL was quantified with data resampling percentage ranging from 12.5% to 100% with a step width at 12.5%. The R, MD and STD were then measured and presented as curves. The evolution curves showed that the R of SAL always remained at high levels of ˜0.9, even when only 12.5% of the data was used to train the model. On the contrary, the R of RGBL can be even lower than 0.6. In all methods except for SVM, the prediction biases of SAL are close to 0, smaller or at least comparable to RGBL predictions. In SVM, the bias of SAL is unneglectable, but still 50% smaller than that of RGBL. The prediction error of SAL slightly increases with smaller sample size but overall lower than 75 μmol/L, which is almost the best level the RGBL can achieve. The AUROC value of SAL in all models was above 0.94, which outperforms that of RGBL in all algorithms. Besides the enhancements exist in absolute values, the SAL curves seem to perform higher stability in all groups than RGBL curves. The standard deviations of these four indices in all groups were quantified with different sample sizes and algorithms. The standard deviations of R, MD, STD and AUROC in RGBL prediction are 259%, 102%, 192% and 100% higher than those in SAL prediction. All these merits demonstrated that even though benefits may be obtained by using an ensemble of models (e.g., models that are weaker for some applications may be outbalanced by the remaining models that are stronger), SAL as enabled by the light-emitting compound measurement app 104 may be able to significantly augment the BBL prediction quality regardless of the specific learning algorithms used. In this case, it is reasonable to expect that any machine learning augmentation can be added when deploying the light-emitting compound measurement app 104 for applications other than bilirubin level detection as demonstrated here.

The complete disclosure of all patents, patent applications, and publications, and electronically available material cited herein are incorporated by reference in their entirety. Supplementary materials referenced in publications (such as supplementary tables, supplementary figures, supplementary materials and methods, and/or supplementary experimental data) are likewise incorporated by reference in their entirety. In the event that any inconsistency exists between the disclosure of the present application and the disclosure(s) of any document incorporated herein by reference, the disclosure of the present application shall govern.

The foregoing detailed description and examples have been given for clarity of understanding only. No unnecessary limitations are to be understood therefrom. The disclosure is not limited to the exact details shown and described, for variations obvious to one skilled in the art will be included within the disclosure defined by the claims.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure.

Specific elements of any foregoing embodiments can be combined or substituted for elements in other embodiments. Moreover, the inclusion of specific elements in at least some of these embodiments may be optional, wherein further embodiments may include one or more embodiments that specifically exclude one or more of these specific elements. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, 10 when used in this application, shall refer to this application as a whole and not to any particular portions of the application.

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present disclosure. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. All numerical values, however, inherently contain a range necessarily resulting from the standard deviation found in their respective testing measurements.

All headings are for the convenience of the reader and should not be used to limit the meaning of the text that follows the heading, unless so specified.

All of the references cited herein are incorporated by reference. Aspects of the disclosure can be modified, if necessary, to employ the systems, functions, and concepts of the above references and application to provide yet further embodiments of the disclosure. These and other changes can be made to the disclosure in light of the detailed description.

It will be appreciated that, although specific embodiments of the disclosure have been described herein for purposes of illustration, various modifications may be made without deviating from the spirit and scope of the disclosure. Accordingly, the disclosure is not limited except as by the claims.

### EXAMPLES

The following paragraphs list non-limiting examples of embodiments of the present disclosure.

Example 1. A computer-implemented method of measuring light-emitting compounds using a smartphone, the method comprising: presenting, by the smartphone, a user interface for configuring a light-emitting compound measurement application; determining, by the smartphone, a transformation matrix using one or more options specified via the user interface; capturing, by the smartphone, a low-color space image that depicts at least a subject; transforming, by the smartphone, the low-color space image into a multispectral data cube using the transformation matrix; and determining, by the smartphone, a measurement of a light-emitting compound associated with the subject using the multispectral data cube.

Example 2. The computer-implemented method of Example 1, wherein the light-emitting compound is a chromophore or a fluorophore.

Example 3. The computer-implemented method of Example 1 or 2, wherein the user interface includes a setting for specifying a model of the smartphone; and wherein determining the transformation matrix includes retrieving a transformation matrix associated with the specified model of the smartphone.

Example 4. The computer-implemented method of any one of Examples 1-3, wherein the user interface includes a setting for specifying a type of color chart; and wherein determining the transformation matrix includes: retrieving expected values for the specified type of color chart; and comparing values from a low-color space image of a physical color chart to the expected values.

Example 5. The computer-implemented method of Example 4, wherein the low-color space image that depicts at least the subject also depicts the physical color chart.

Example 6. The computer-implemented method of any one of Examples 1-5, wherein the user interface includes a setting for specifying a region of interest size; and wherein determining the measurement of the light-emitting compound associated with the subject using the multispectral data cube includes: extracting values from the multispectral data cube based on the specified region of interest size.

Example 7. The computer-implemented method of any one of Examples 1-6, wherein determining the measurement of the light-emitting compound includes: providing values from the multispectral data cube to an ensemble of two or more machine learning models; and determining the measurement of the light-emitting compound based on outputs of the two or more machine learning models.

Example 8. The computer-implemented method of Example 7, wherein determining the measurement of the light-emitting compound based on the outputs of the two or more machine learning models includes averaging the outputs of the two or more machine learning models.

Example 9. The computer-implemented method of any one of Examples 7 or 8, wherein the ensemble of two or more machine learning models includes an artificial neural network (ANN), a support vector machine (SVM), a k-nearest neighbors (KNN) model, and a random forest (RF).

Example 10. The computer-implemented method of any one of Examples 1-9, wherein the measurement of the light-emitting compound is a blood bilirubin concentration, a hemoglobin level, a melanin level, a porphyrin concentration, or a bacteria load level.

Example 11. A computer-implemented method of measuring light-emitting compounds using a smartphone, the method comprising: capturing, by the smartphone, a low-color space image that depicts at least a subject; transforming, by the smartphone, the low-color space image into a multispectral data cube using a transformation matrix; providing, by the smartphone, values from the multispectral data cube to an ensemble of two or more machine learning models; and determining, by the smartphone, a measurement of a light-emitting compound associated with the subject based on outputs of the two or more machine learning models.

Example 12. The computer-implemented method of Example 11, wherein the light-emitting compound is a chromophore or a fluorophore.

Example 13. The computer-implemented method of any one of Examples 11 or 12, wherein determining the measurement of the light-emitting compound based on the outputs of the two or more machine learning models includes averaging the outputs of the two or more machine learning models.

Example 14. The computer-implemented method of any one of Examples 11-13, wherein the ensemble of two or more machine learning models includes an artificial neural network (ANN), a support vector machine (SVM), a k-nearest neighbors (KNN) model, and a random forest (RF).

Example 15. The computer-implemented method of any one of Examples 11-14, wherein the measurement of the light-emitting compound associated with the subject is a blood bilirubin concentration, a hemoglobin level, a melanin level, a porphyrin concentration, or a bacteria load level.

Example 16. The computer-implemented method of any one of Examples 11-15, further comprising determining, by the smartphone, the transformation matrix using one or more options specified by via a user interface.

Example 17. The computer-implemented method of Example 16, wherein the user interface includes a setting for specifying a model of the smartphone; and wherein determining the transformation matrix includes retrieving a previously determined transformation matrix associated with the specified model of the smartphone.

Example 18. The computer-implemented method of any one of Examples 16 or 17, wherein the user interface includes a setting for specifying a type of color chart; and wherein determining the transformation matrix includes: retrieving expected values for the specified type of color chart; and comparing values from a low-color space image of a physical color chart to the expected values.

Example 19. The computer-implemented method of Example 18, wherein the low-color space image that depicts at least the subject also depicts the physical color chart.

Example 20. The computer-implemented method of any one of Examples 16-18, wherein the user interface includes a setting for specifying a region of interest size; and wherein determining the measurement of the light-emitting compound associated with the subject using the multispectral data cube includes: extracting values from the multispectral color cube based on the specified region of interest size.

Example 21. A smartphone configured to perform a method as recited in any one of Examples 1-20.

Example 22. A non-transitory computer-readable medium having computer-executable instructions stored thereon, that, in response to execution by one or more processors of a smartphone, cause the smartphone to perform a method as recited in any one of Examples 1-20.

1. A computer-implemented method of measuring light-emitting compounds using a smartphone, the method comprising:
presenting, by the smartphone, a user interface for configuring a light-emitting compound measurement application;
determining, by the smartphone, a transformation matrix using one or more options specified via the user interface;
capturing, by the smartphone, a low-color space image that depicts at least a subject;
transforming, by the smartphone, the low-color space image into a multispectral data cube using the transformation matrix; and
determining, by the smartphone, a measurement of a light-emitting compound associated with the subject using the multispectral data cube.

2. The computer-implemented method of claim 1, wherein the light-emitting compound is a chromophore or a fluorophore.

3. The computer-implemented method of claim 1, wherein the user interface includes a setting for specifying a model of the smartphone; and
wherein determining the transformation matrix includes retrieving a transformation matrix associated with the specified model of the smartphone.

4. The computer-implemented method of claim 1, wherein the user interface includes a setting for specifying a type of color chart; and
wherein determining the transformation matrix includes:
retrieving expected values for the specified type of color chart; and
comparing values from a low-color space image of a physical color chart to the expected values.

5. The computer-implemented method of claim 4, wherein the low-color space image that depicts at least the subject also depicts the physical color chart.

6. The computer-implemented method of claim 1, wherein the user interface includes a setting for specifying a region of interest size; and
wherein determining the measurement of the light-emitting compound associated with the subject using the multispectral data cube includes:
extracting values from the multispectral data cube based on the specified region of interest size.

7. The computer-implemented method of claim 1, wherein determining the measurement of the light-emitting compound includes:
providing values from the multispectral data cube to an ensemble of two or more machine learning models; and
determining the measurement of the light-emitting compound based on outputs of the two or more machine learning models.

8. The computer-implemented method of claim 7, wherein determining the measurement of the light-emitting compound based on the outputs of the two or more machine learning models includes averaging the outputs of the two or more machine learning models.

9. The computer-implemented method of claim 7, wherein the ensemble of two or more machine learning models includes an artificial neural network (ANN), a support vector machine (SVM), a k-nearest neighbors (KNN) model, and a random forest (RF).

10. The computer-implemented method of claim 1, wherein the measurement of the light-emitting compound is a blood bilirubin concentration, a hemoglobin level, a melanin level, a porphyrin concentration, or a bacteria load level.

11. A computer-implemented method of measuring light-emitting compounds using a smartphone, the method comprising:
capturing, by the smartphone, a low-color space image that depicts at least a subject;
transforming, by the smartphone, the low-color space image into a multispectral data cube using a transformation matrix;
providing, by the smartphone, values from the multispectral data cube to an ensemble of two or more machine learning models; and
determining, by the smartphone, a measurement of a light-emitting compound associated with the subject based on outputs of the two or more machine learning models.

12. The computer-implemented method of claim 11, wherein the light-emitting compound is a chromophore or a fluorophore.

13. The computer-implemented method of claim 11, wherein determining the measurement of the light-emitting compound based on the outputs of the two or more machine learning models includes averaging the outputs of the two or more machine learning models.

14. The computer-implemented method of claim 11, wherein the ensemble of two or more machine learning models includes an artificial neural network (ANN), a support vector machine (SVM), a k-nearest neighbors (KNN) model, and a random forest (RF).

15. The computer-implemented method of claim 11, wherein the measurement of the light-emitting compound associated with the subject is a blood bilirubin concentration, a hemoglobin level, a melanin level, a porphyrin concentration, or a bacteria load level.

16. The computer-implemented method of claim 11, further comprising determining, by the smartphone, the transformation matrix using one or more options specified by via a user interface.

17. The computer-implemented method of claim 16, wherein the user interface includes a setting for specifying a model of the smartphone; and
wherein determining the transformation matrix includes retrieving a previously determined transformation matrix associated with the specified model of the smartphone.

18. The computer-implemented method of claim 16, wherein the user interface includes a setting for specifying a type of color chart; and
wherein determining the transformation matrix includes:
retrieving expected values for the specified type of color chart; and
comparing values from a low-color space image of a physical color chart to the expected values.

19. The computer-implemented method of claim 18, wherein the low-color space image that depicts at least the subject also depicts the physical color chart.

20. The computer-implemented method of claim 16, wherein the user interface includes a setting for specifying a region of interest size; and
wherein determining the measurement of the light-emitting compound associated with the subject using the multispectral data cube includes:
extracting values from the multispectral color cube based on the specified region of interest size.

21-22. (canceled)
